(19) United States
(12) Patent Application Publication
(10) Pub. No.: US 2018/0311888 A1
(43) Pub. Date: Nov. 1, 2018

(54) FURNITURE COMPONENTS WITH EMBOSSED PROFILES

(71) Applicant: Lifetime Products, Inc., Clearfield, UT (US)

(72) Inventors: Preston Winter, Morgan, UT (US); Josh Clark, Clearfield, UT (US)

(21) Appl. No.: 15/962,971

(22) Filed: Apr. 25, 2018

Related U.S. Application Data
(63) Continuation-in-part of application No. 29/601,877, filed on Apr. 26, 2017.
(60) Provisional application No. 62/490,550, filed on Apr. 26, 2017.

(51) Int. Cl. B29C 59/02; B29C 59/00; B21D 17/04

(52) U.S. Cl. CPC B29C 59/021; A47B 3/002; B21D 17/04; B29C 59/005

(57) ABSTRACT

An article of furniture may include a component such as a frame, leg, or support. The component may be constructed from a strip of material and the strip of material may include a strip length, a strip width, and a strip thickness. The component may include a longitudinal welding joint that may be disposed between a first strip end or a first strip side and a second strip end or second strip side. A profile may be embossed into a surface of the strip of material and the component may be manufactured in a continuous inline roll forming process.

### CROSS REFERENCE TO RELATED APPLICATIONS

The present application claims priority to and the benefit of U.S. Provisional Patent Application Ser. No. 62/490,550, entitled FURNITURE INCLUDING COMPONENTS HAVING EMBOSSED PROFILES, which was filed on Apr. 26, 2017, and is incorporated by reference in its entirety.

The present application is a continuation in part of U.S. patent application Ser. No. 29/601,877, entitled CHAIR, which was filed on Apr. 26, 2017, and is incorporated by reference in its entirety.

### BACKGROUND OF THE INVENTION

### Field of the Invention

This application is generally directed towards furniture and, in particular, furniture components with embossed profiles and methods of manufacturing furniture components with embossed profiles.

### Description of Related Art

Furniture, such as tables, chairs, and benches, may include components such as frames and/or legs. These components may retain other components, such as tabletops, chairs seats, sitting surfaces, backrests, etc., relative to one another. These components may also position other components in desired locations, alignments, and directions. Additionally, components such as legs may support the furniture above a surface such as a floor.

Conventional chairs, for example, typically include a chair seat and a backrest. The chair seat and backrest can be separate structures or part of a single structure. Most chairs are used by one person at a time. Chairs typically include legs to support the chair seat and backrest above a surface such as a floor. Chairs may be constructed from a wide variety of materials such as wood, metal, and molded plastic. Conventional chairs may have a wide variety of designs depending on factors such as intended use, ergonomics, and appearance. In addition, known chairs may have various functional considerations such as size, weight, durability, portability, and desired seating position.

Some known chairs may be stacked together to form an orderly group, which may facilitate transportation and storage of the chairs. Conventional chairs may also be aligned to allow the chairs to be more conveniently transported and stored. Chairs that may be stacked together with other chairs may be referred to as “stacking chairs” or “stackable chairs” and these types of chairs are frequently used in assembly halls, banquet halls, convention centers, hotels, schools, churches, and other locations where large groups of people meet. When needed for seating, stackable chairs may be positioned in an assortment of configurations and arrangements. When the stackable chairs are no longer needed for seating, the chairs may be stacked for easy transportation and/or storage.

Folding chairs are also known. Most folding chairs are lightweight, portable chairs that can be folded into a collapsed position. In particular, most folding chairs can be moved between a folded position, which may be useful for storage or transport, and an unfolded position in which the chairs are intended to be used. Folding chairs are generally used for seating in areas where permanent seating is not possible or practical. Folding chairs may also be used during outdoor or indoor events such as performances, presentations, and sporting events. In addition, folding chairs may be used in commercial or residential settings, such as when extra seating is needed for parties, celebrations, gatherings, and events.

Traditional folding chairs often include folding chair legs that can pivot between folded or collapsed positions and unfolded or open positions. Disadvantageously, some known folding chairs are not very sturdy, strong, durable, or well-made. In addition, some known folding chairs are difficult to use and may be challenging to secure in the use or collapsed positions. These problems may be especially difficult for chairs that are lightweight and comparatively inexpensive.

Conventional folding chairs also may not be able to support a large amount of weight or force. Further, conventional folding chairs may be rather time-consuming to manufacture and assemble. For example, known folding chairs may include a number of discrete parts that must be carefully assembled, which can undesirably increase the time required to manufacture the chairs.

Tables may also include components such as frames and legs, which may also be referred to as supports or support members. Many different types of tables are well known and used for a variety of different purposes. For example, conventional tables may include legs that are pivotally attached to a tabletop and the legs may be movable between a use position in which the legs extend outwardly from the tabletop and a storage position in which the legs are folded against or underneath portion of the tabletop. Conventional tables with relatively large tabletops and folding legs are often referred to as “banquet tables” and these tables are frequently used in assembly halls, banquet halls, convention centers, hotels, schools, churches, and other locations where large groups of people meet. When the tables are no longer needed, the table legs can be moved into the storage position and the tables may be moved or stored.

Conventional banquet tables with movable legs may allow the tables to be more conveniently stored and transported. For example, banquet tables with movable legs may allow the tables to be disposed in a stacked configuration for storage or transport. The movable legs may be particularly useful because conventional banquet tables may have a length between six and ten feet and a width between three and four feet, and the large size may make the tables difficult to move or store.

It is also known to construct tables that are capable of being folded in half. Conventional fold-in-half tables may include a tabletop with two sections pivotally connected by hinges. The two sections usually have the same size and shape, and the hinges are typically located at the center or middle of the tabletop. The two sections of the tabletop may be moved between an unfolded position or use in which the sections of the tabletop are generally aligned in the same plane and a folded or collapsed position in which the two sections are positioned generally adjacent to each other for storage.

Conventional tables and chair may include tubular structures and the tubular structures may be hollow, substantially hollow, or include one or more substantially hollow portions. For example, the legs of a table or chair may be constructed from tubular structures and these tubular structures may have a circular cross-sectional configuration. The tubular structures may be comprised at least partially of an outer shell and there may not be another component positioned within the shell. The tubular structures may be attached to other components such as a tabletop, a seat back, a seat, and/or to one or more other components via fasteners, press fit joints, and the like.

The tubular structures of conventional tables and chairs may be manufactured by a roll forming process. In the roll forming process, a strip of material may be formed into the tubular structure as the strip of material moves through a series of rollers. Each roller of the series of rollers may modify the dimensions and configuration of the strip of material towards the final tubular structure.

Conventional tables and chairs typically have components with a smooth outer surface because construction of components with a smooth outer surface may simplify the manufacturing process. For example, strips of material may be pulled directly from a coil of metal, such as steel, to form the components. The roll forming process may form the strips of metal into the tubular structures that may be used, for example, to construct tables, chairs, and other desired types of furniture.

### BRIEF SUMMARY OF EMBODIMENTS OF THE INVENTION

Furniture, such as tables and chairs, may include one or more components with a generally cylindrical, tubular, and/or tube-shaped configurations. These components may be hollow, solid, and/or a combination of hollow and solid portions. These components may have an outer surface that is generally round, circular, oval, elliptical, oblong, elongated, and the like. Thus, these components may have one or more rounded or curved outer surfaces. These components may also have one or more generally straight or flat outer surfaces. Therefore, these components may include one or more surfaces that are rounded or curved, and one or more surfaces that are generally straight or flat. Accordingly, the components may have a cross-sectional configuration that is generally round, circular, oval, elliptical, oblong, elongated, square, rectangular, polygon, and the like. One skill in the art will appreciate, after reviewing this disclosure, that the components may have any suitable number of round, curved, bent, straight, and/or flat sections depending, for example, upon the intended use of the components and/or furniture.

These components may be manufactured according to a roll forming process and the components may have an embossed profile. For example, a strip of material may include an embossed profile and the strip of material may be formed into the desired shape during a roll forming process. The manufacturing process may also include embossing a profile onto a strip of material and then forming the strip of material into the desired shape. The manufacturing process, however, may omit the step of embossing a profile into the strip of material, which may speed up the manufacturing process. Thus, the components may have a generally smooth outer surface if the step of embossing a profile into the strip of material is omitted. The construction of components with a smooth outer surface, however, may limit the design character of the furniture. Additionally, material property benefits such as rigidity, durability, and strength, which may result from an embossed profile, may not be available if the components have a smooth outer surface.

In some embodiments, the profile may be embossed into the material and then the material may be formed into the desired shape during, for example, the roll forming process. Disadvantageously, a large amount of material may have to be embossed, such as an entire coil of material. The embossed coil of material may then be cut into strips of material, which may then be formed into the desired components. This manufacturing process may result in waste and poor quality components. For example, the profile embossed on the entire coil may not align with the width of the strips of material. Accordingly, some amount of material may be cut from one or both ends of the strips of material to ensure a consistent profile. Additionally, the profile embossed on the entire coil may result in a poorly aligned profile at the ends of the strips of material. Poor alignment of the profile may result in gaps when the tubular structure is formed. The gaps may result in an inconsistent welding joint between the ends or excessively large welding joint between the ends to accommodate for the gaps.

A need therefore exists for components that eliminates the above-described disadvantages and problems.

One aspect is a method of manufacturing a component of an article of furniture, such as a frame, support, or leg for a table or chair. The method may include receiving a strip of material. The strip of material may be received from an accumulator. The strip of material may include a portion of a coil of stock material. The strip of material may include a strip width defined between a first strip end or first strip side and a second strip end or second strip side. The strip of material may include a strip length and the strip length may be larger than the strip width. The strip of material may include an initial cross section and the initial cross section may be defined by a plane that is substantially perpendicular to the strip length. The initial cross section may be generally rectangular and may include the strip width and a strip thickness as one or more dimensions. The strip of material, for example, may be constructed from steel, such as a carbon steel or a stainless steel. In an exemplary process, such as a first inline process, the method may include embossing a profile into a surface of the received strip of material. The embossing the profile may be performed by a roll forming process. In an exemplary process, such as a second inline process, which may be subsequent to the first inline process, the method may include modifying a shape of the strip of material such that the initial cross section is transformed to a second cross section. The modifying the shape may be performed by a roll forming process including one or more rollers, such as at least two rollers. The second cross section, for example, may be substantially circular, substantially rectangular, substantially oval, etc. The second cross section may include the first strip end or the first strip side positioned substantially adjacent to the second strip end or the second strip side. The profile may be defined such that in the second cross section, the first strip end, the first strip side, the second strip end, and/or the second strip side are separated by a uniform or substantially uniform distance along the strip length. In an exemplary embodiment, the profile may include a pattern of offset ribs formed in a surface of the received strip of material and an opposite surface of the received strip of material. In an exemplary process, such as a third inline process, which may be subsequent to the second inline process, the method may include welding a longitudinal welding joint between the first strip end or the first strip side and the second strip end or the second strip side along at least a portion of the strip length. In an example process, such as a fourth inline process, which may be subsequent to the third inline process, the method may include removing material from the welding joint. In an exemplary process, such as a fifth inline process, which may be subsequent to the fourth inline process, the method may include cutting the strip of material in a plane of the second cross section. The first inline process may be performed at a same line rate of the second inline process and the third inline process. The components manufactured according to these exemplary methods may be used to form or construct at least a portion of an article of furniture. These components, which may form part of the article of furniture, may include a leg of a table, a leg of a chair, a support frame of a table, a support frame of a chair, a leg of a bench, a leg of a picnic table, a support frame of a bench, a support frame of a picnic table, a support structure of a composter, and the like.

Another aspect is article of furniture and the article of furniture may include a component, such as a frame, support, or leg for a table or chair. The component may include a strip of material and a profile. The strip of material may include a portion of a coil of stock material. The strip of material may include a strip length defined in a longitudinal direction, a strip width defined between a first strip end or a first strip side and a second strip end or a second strip side, a strip thickness, and/or a longitudinal welding joint between the first strip end or the first strip side and the second strip end and the second strip side along at least a portion of the strip length. The profile may be embossed into a surface of the strip of material and the strip length may be larger than the strip width. The component may be manufactured in a continuous inline roll forming process. In the continuous inline roll forming process, the profile may be embossed in a first inline process. In the continuous inline roll forming process, a shape of the strip of material may be modified from an initial generally rectangular cross section to a second cross section in a second inline process, which may be subsequent to the first inline process. In the continuous inline roll forming process, the longitudinal welding joint may be formed in a third inline process, which may be subsequent to the second inline process. In greater detail, the component may include a table leg, a table frame, a chair leg, a chair frame, a bench leg, a picnic table leg, and the like.

Advantageously, the embossed profile may provide several benefits to the components. For instance, the embossed profile may increase rigidity and/or strength of the component. Additionally, the embossed profile may add durability to the surface of the component, which may hide or prevent surface damage. In addition, the embossed profile may provide aesthetic benefits to the component. The continuous inline roll forming process may also provide substantial benefits over other manufacture processes. For instance, in previous manufacture processes, the profile may be embossed on an entire coil and the coil would then be cut into strips of material. The strips of material would then be roll formed and welded. This previous process introduced significant wastes. For instance, if the entire coil is embossed, that may result in some portion of embossed material not being used. Additionally, the cutting of the embossed coiled material interrupts the profile. Accordingly, at the locations in which the cuts are made, there may be inconsistencies that lead to a poor weld or inconsistent products. Further, embossing of the entire coil introduces an entire process that occurs outside the specific component manufacturing process. This may introduce inefficiencies in the handling of the material. These wastes may be overcome by the continuous inline roll forming process. The continuous inline roll forming may provide better control over the material that is embossed and the position of the profile on the strip of material. This control reduces wastes described above and ensures that the embossed profile does not reduce the quality of the weld.

These and other aspects, features, and advantages of the present invention will become more fully apparent from the following brief description of the drawings, the drawings, the detailed description of preferred embodiments, and appended claims.

### BRIEF DESCRIPTION OF THE DRAWINGS

The appended drawings contain figures of exemplary embodiments to further illustrate and clarify the above and other aspects, advantages, and features of the present disclosure. It will be appreciated that these drawings depict only exemplary embodiments of the invention and are not intended to limit its scope. Additionally, it will be appreciated that while the drawings may illustrate exemplary sizes, scales, relationships, and configurations of the present disclosure, the drawings are not intended to limit the scope of the claimed invention. The present disclosure will be described and explained with additional specificity and detail through the use of the accompanying drawings in which:

FIG. 1A is a bottom perspective view of an exemplary table, illustrating one or more components of the table may have an embossed profile;

FIG. 1B is an upper perspective view of the table shown in FIG. 1;

FIG. 2A is a perspective view of an exemplary structure that may have an embossed profile, the exemplary structure may be used to form all or a portion of a component, such as frame, legs, and/or other portions of the table shown in FIGS. 1A and 1B;

FIG. 2B is another perspective view of the structure with an embossed profile shown in FIG. 2A;

FIG. 2C is a side view of the structure with an embossed profile shown in FIG. 2A;

FIG. 3A is a lower perspective view of an exemplary chair, illustrating one or more components of the chair may have an embossed profile;

FIG. 3B is an upper perspective view of the chair shown in FIG. 3A;

FIG. 4A is a perspective view of another exemplary structure that may have an embossed profile, the exemplary structure may be used to form all or a portion of a components, such as the frame, legs, and/or other portions of the chair shown in FIGS. 3A and 3B;

FIG. 4B is another perspective view of the structure with an embossed profile shown in FIG. 4A;

FIG. 4C is still another perspective view of the structure with an embossed profile shown in FIG. 4A;

FIG. 4D is a side view of the structure with an embossed profile shown in FIG. 4A;

FIG. 5A is a top view of an exemplary system that may be implemented to manufacture one or more components having an embossed profile;

FIG. 5B is a side view of the system shown in FIG. 5A;

FIG. 6A is an enlarged end view of an exemplary strip of material with an embossed profile;

FIG. 6B is a perspective view of the strip of material with an embossed profile shown in FIG. 6A;

FIG. 7 is a flow chart of an exemplary method of manufacturing a component of an article of furniture;

FIG. 8 is an upper perspective view of an exemplary embodiment of a chair, illustrating a chair with one or more components with an embossed profile;

FIG. 9 is an enlarged view of a portion of the chair shown in FIG. 8, which is identified by reference number 9;

FIG. 10 is an enlarged view of a portion of the chair shown in FIG. 8, which is identified by reference number 10;

FIG. 11 is a front view of the chair shown in FIG. 8;

FIG. 12 is an enlarged view of a portion of the chair shown in FIG. 11, which is identified by reference number 12;

FIG. 13 is a rear view of the chair shown in FIG. 8;

FIG. 14 is a left side view of the chair shown in FIG. 8;

FIG. 15 is a right side view of the chair shown in FIG. 8;

FIG. 16 is a top view of the chair shown in FIG. 8;

FIG. 17 is a bottom view of the chair shown in FIG. 8; and

FIG. 18 is a cross sectional view of a portion of the chair shown in FIG. 8, which is identified by lines 18-18.

### DETAILED DESCRIPTION OF SOME EXEMPLARY EMBODIMENTS

The present disclosure is generally directed towards furniture that may include one or more components with an embossed profile. The principles of the present disclosure, however, are not limited to the furniture, components, or profiles that are explicitly described or depicted. For example, it will be understood that, in light of the present disclosure, the furniture, components, and profiles may have a variety of shapes, sizes, configurations, and arrangements. It will also be understood that the furniture and components may include any suitable number and combination of features, components, aspects, and the like. Additionally, it will be understood that the components and profiles may be used in connection with other structures, which may not be related to furniture. In addition, while the furniture, components, and profiles shown in the accompanying figures are illustrated as having particular shapes, sizes, styles, configurations, and arrangements, it will be appreciated the furniture, components, and profiles may have any suitable shapes, sizes, styles, configurations and arrangements. Further, the furniture and components having an embossed profile disclosed herein may be successfully used in connection with other types of objects and devices.

Additionally, to assist in the description of various exemplary embodiments of the furniture, components, and profiles, words such as top, bottom, front, rear, sides, right, and left are used to describe the accompanying figures which may be, but are not necessarily, drawn to scale. It will further be appreciated that the furniture, components, and profiles may be disposed in a variety of desired positions or orientations, and used in numerous locations, environments, and arrangements. A detailed description of exemplary embodiments of the disclosure now follows.

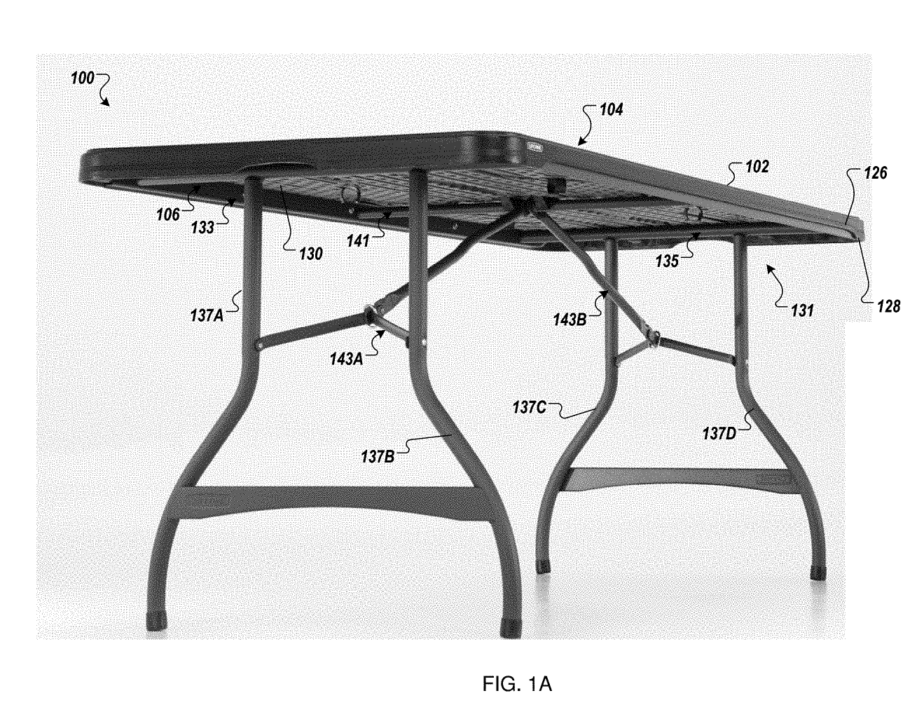

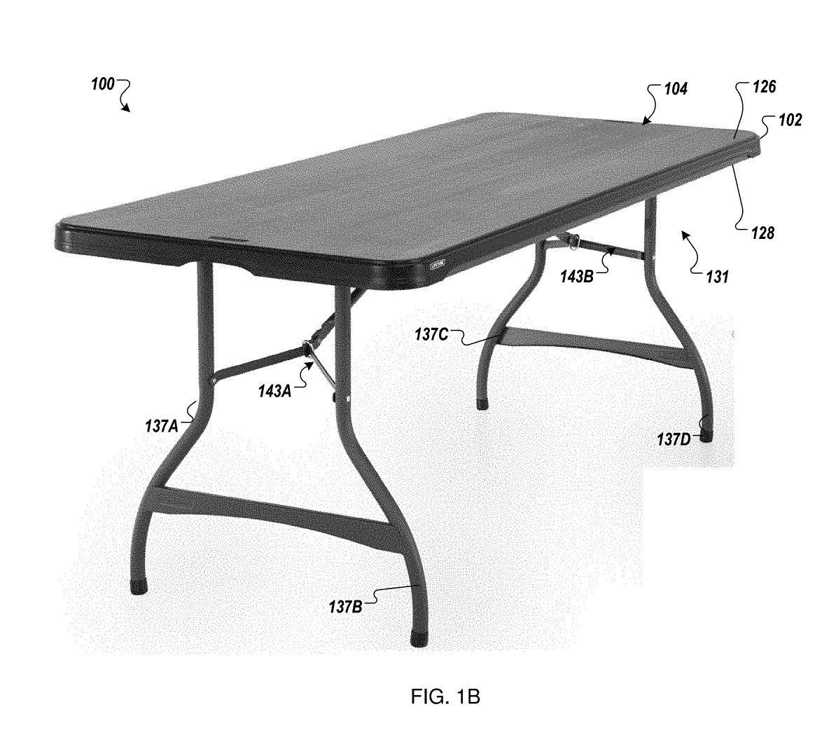

FIGS. 1A and 1B illustrate an exemplary table 100 in which one or more components with an embossed profile may be implemented. FIG. 1A is a bottom perspective view of the table 100. FIG. 1B is an upper perspective view of the table 100. With combined reference to FIGS. 1A and 1B, the table 100 may include a table top 102 with an upper surface 104 (FIG. 1B) and a lower surface 106 (FIG. 1A). The upper surface 104 of the table top 102 may be generally planar, which may create a smooth, flat working surface. The upper surface 104 may also be textured and have other suitable configurations depending, for example, upon the intended use of the table 100. The table top 102 may also include an edge 126 that is disposed about the outer perimeter or periphery of the table top. All or a portion of the edge 126 may be beveled, sloped or rounded to, for example, increase the comfort and safety of the user. The table top 102 may also include a downwardly extending lip 128 and the lip may be disposed near or at the outer portion of the table top 102. The lip 128 may extend downwardly beyond the lower surface 106 of the table top 102 and the lip may be aligned with or form a part of the edge 126 of the table top. It will be appreciated that the lip 128 may also be spaced inwardly from the edge 126 of the table top 102.

The table top 102 may have a generally rectangular configuration with rounded corners and slightly rounded edges 126. The table top 102 may have a relatively large size and may be configured for use as a banquet style table. In particular, the table top 102 may have a length of about five feet (or about sixty inches) and a width of about two and one-half feet (or about thirty inches), but the table top can be larger or smaller. For example, the table top 102 may be six or eight feet in length, and the table top could be two or three feet in width. One skilled in the art will appreciate that the table top 102 can be larger or smaller according, for example, to the intended use of the table 100. Additionally, the table top 102 may have other suitable shapes, sizes, configurations, and arrangements such as square, circular, oval, and the like depending, for example, upon the intended use of the table 100. In addition, the corners and edges 126 of the table top 102 do not have to be rounded and, in contrast, the corners and edges could have any desirable configuration, but the rounded features may increase the comfort and/or safety of the user. Further, the table top 102 could be sized and configured for use with other types of tables such as utility tables, card tables, personal-sized tables, and the like.

The table top 102 may be constructed from a lightweight material and, in an exemplary embodiment, the table top 102 may be constructed from plastic, such as high-density polyethylene. The plastic table top 102 may be formed form a blow-molding process and a blow-molded plastic table top may be strong, lightweight, rigid, and sturdy table top to be constructed. The blow-molded plastic table top 102 may also be quickly and easily manufactured. Advantageously, the blow-molded plastic table top 102 may be lighter weight than conventional table tops constructed from wood or metal. The blow-molded plastic table top 102 may be lightweight because it may be substantially hollow. It will be appreciated that the substantially hollow table top 102 can include table tops that are generally hollow or completely hollow. The table top 102, however, does not have to be hollow or include any portions that are hollow.

The table top 102 may be constructed from blow-molded plastic because blow-molded plastic table tops may be relatively durable, weather resistant, temperature insensitive, corrosion resistant, rust resistant, and blow-molded plastic generally does not deteriorate over time. One skilled in the art, after reviewing this disclosure, will appreciate that the table top 102 does not have to be constructed from blow-molded plastic and other suitable materials and/or processes can be used to construct the table top 102 such as other types of plastics, polymers and synthetic materials. In addition, the table top 102 may be constructed from other materials with sufficient strength and desirable characteristics such as plywood, particle board, solid wood, wood slates, metal alloys, fiberglass, ceramics, graphite, and the like.

The upper surface 104 and the lower surface 106 of the table top 102 may be spaced apart by a given distance and these two spaced apart surfaces may help create a rigid and strong table top 102. The upper surface 104 and the lower surface 106 may be separated by a generally constant distance so that the surfaces are generally aligned in parallel planes. The upper and lower surfaces 104, 106 of the table top 102 may also be interconnected by one or more tack-offs, kiss-offs or depressions 130, or other reinforcement structures, which may be sized and configured to increase the strength and/or rigidity of the table top 102. Advantageously, the depressions 130 and/or other reinforcement structures may be integrally formed as part of a unitary, one-piece table top 102 during the blow-molding process.

The depressions 130 may be located in the lower surface 106 of table top 102 and the depressions may be sized and configured to increase the strength and/or structural integrity of the table top 102. Other features formed in the table top 102 may be sized and configured such that they do not significantly disturb or disrupt the desired pattern of depressions 130. In addition, the depressions 130 may be integrally formed in the table top 102 as part of a unitary, one-piece structure. Advantageously, the depressions 130 can be integrally formed in the table top 102 during the blow-molding process.

A frame 131 may be connected to the lower surface 106 of the table top 102. The frame 131 may include two side rails 133 that extend along the length of the table top 102. The side rails 133 may extend almost the entire length of the table top 102, which may provide increased strength and/or rigidity for the table top 102. In some embodiments, all or a portion of the side rails 133 may be embossed with a profile. The frame 131 may also include one or more end rails 135, which may be attached to the ends of the side rails 133, and a center rail 141, which may be positioned approximately in the center of the table top 102.

The frame 131 may include angled support rails 143A and 143B (generally, angled support rail 143 or angled support rails 143). The angled support rails 143 may include one end connected to the table top 102 and/or the frame 131, such as the center rail 141. The angled support rails 143 may include another end that is connected to the legs, such as the legs 137A-137D (generally, leg 137 or legs 137). The angled support rails 143 may include a hinge that can be locked when the legs 137 are in an extended position (as shown in FIGS. 1A and 1B). It will be appreciated that the frame 131, angled support rails 143, and legs 137 may have other suitable shapes, sizes, configurations and/or arrangements, depending, for example, upon the size and shape of the table top 102 or the intended use of the table 100.

The frame 131 may include one or more components with an embossed profile (e.g., 133, 135, and 143). The frame 131 may also include one or more components that may be formed by a continuous inline roll forming process, which is described elsewhere in the present disclosure. One or more components of the frame 131 may also be formed into the desired configuration by known operations such as stamping and bending. Further, one or more of the components may be coated or painted as desired.

The legs 137 may be sized and configured to support the table top 102 above a surface such as a floor. All or a portion of the legs 137 may be disposed between the side rails 133 of the frame 131. For example, if the legs 137 are rotatably attached to the frame 131, the legs may be disposed between the side rails 133 of the frame 131 when the legs are disposed in a collapsed or storage position. It will be appreciated that the legs 137 may be positioned in any desired locations depending, for example, upon the configuration of the legs 137 and/or the frame 131.

The legs 137 may be movable between a first extended position (as shown in FIGS. 1A and 1B) in which the legs 137 extend away from the table top 102 and a second collapsed position in which the legs are positioned at least proximate the table top 102. In the collapsed position, the hinge of the angled support rails 143 may be in an angled position such that the angled support rails 143 is positioned at least proximate the table top 102.

The legs 137 of the table 100 include an embossed profile. Advantageously, the embossed profile may provide several benefits to the table 100. For instance, the embossed profile may increase rigidity and/or strength of the legs 137. Additionally, the embossed profile may add durability to the surface of the legs 137. The embossed profile may also help hide or prevent surface damage. Further, the embossed profile may allow the legs 137 to have a more pleasing design or appearance. In addition, the embossed profile may provide aesthetic benefits to the table 100, which may allow the table to have different designs, appearances, and configurations.

The legs 137 may be constructed of a metal or from other materials with the suitable characteristics. The legs 137 may have other shapes and configurations depending, for example, upon the intended use of the table 100. For example, the legs 137 may include only a single elongated support member or multiple elongated support members, and the legs 137 may be constructed as a single component or multiple components that are connected together. It will further be appreciated that the legs 137 need not be in pivotal engagement with frame 131 or the table top 102 to be collapsible. For example, the legs 137 may be detachably connected to the table top 102 such that when it is desired to collapse the table 100 for storage, the legs 137 are detached from the table top 102. The legs 137 may also be in a fixed position relative to the table top 102, if desired. It will be appreciated that the legs 137, table top 102, and table 100 may have other suitable sizes, shapes, configurations, and arrangements depending, for example, upon the intended use of the table.

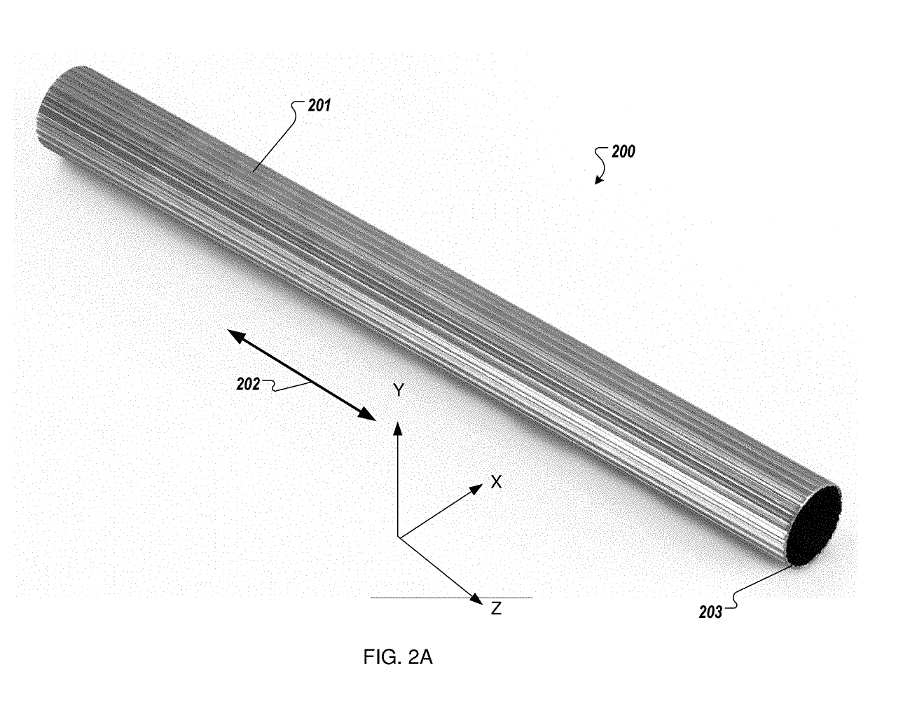

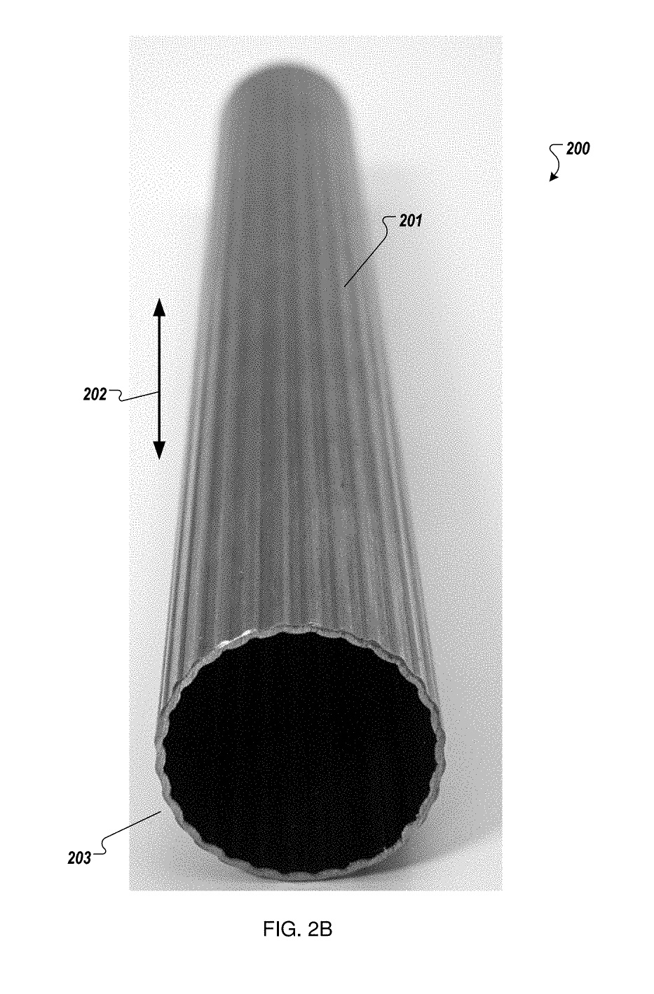

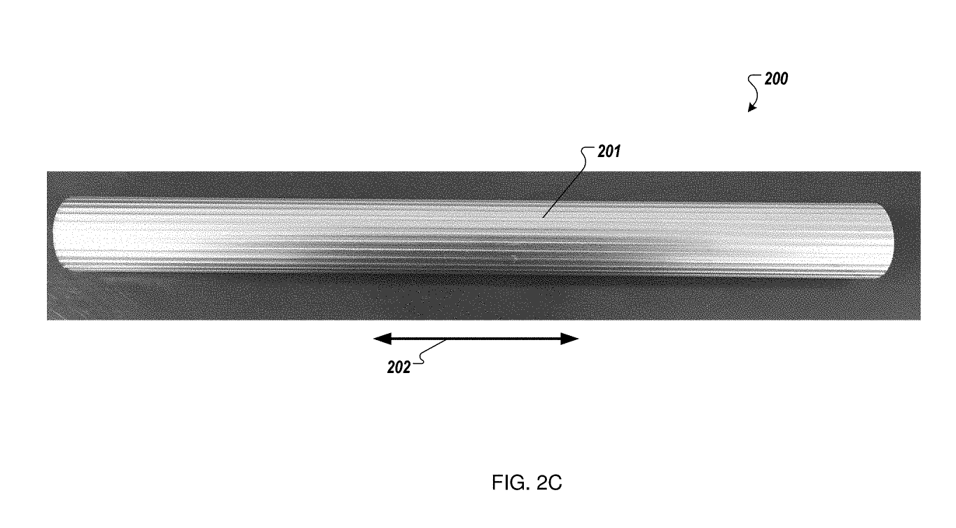

FIGS. 2A-2C illustrate a portion of an exemplary component 200 having an embossed profile. The component 200, for example, may be included in or may form at least a portion of one or more of the legs 137 and/or the frame 131 of the table 100 shown in FIGS. 1A and 1B. FIG. 2A depicts a first perspective view of the component 200. FIG. 2B depicts a second perspective view of the component 200. FIG. 2C depicts a side view of the component 200.

The component 200 may be a tubular structure or a conduit type structure, and the structure may be disposed in a longitudinal direction and/or have a longitudinal length, which may be represented by arrow 202 in FIGS. 2A-2C. The component 200 may include a shell or ring of material. For example, the outer surface of the component 200 may form at least a portion of the shell or ring of material. The component 200 may also form the shell or ring of material. Thus, all or a portion of the component may form the shell or ring of material.

A profile 201 may be embossed in one or more surfaces of the shell or ring of material. In the exemplary embodiment shown in FIGS. 2A-2D, the profile 201 in the component 200 is a set of ribs that extend in the longitudinal direction 202. The ribs may be offset and/or spaced apart, and the ribs may be disposed in a pattern that extends around at least a portion of the shell or ring of material. In other embodiments, another profile may be embossed in the component 200. For example, the profile 201 may include a honeycomb pattern, dimples, pseudorandom patterns of lines and shapes, a pattern of rectangles, triangles, diamond plating, and the like. One skilled in the art, after reviewing this disclosure, will appreciate that the profile 201 may have other suitable shapes, sizes, configurations, and arrangements. Further, after reviewing this disclosure, one skilled in the art will appreciate that the profile 201 may be disposed in different directions, orientations, locations, and the like.

The shell or ring of material may define or form at least a portion of a cross section 203, which is shown in FIGS. 2A and 2B. In an exemplary embodiment, the cross section 203 of the component 200 may be substantially circular. The cross section 203 may be defined by a plane that is substantially perpendicular to the longitudinal direction 202. For instance, as shown in FIG. 2A, an arbitrarily defined Cartesian coordinate system is depicted. The longitudinal direction corresponds to the Z-direction. The cross section 203 is defined in the XY-plane. It will be understood that other coordinate systems may be used and the component 200 may have other suitable cross sections such as generally round, circular, oval, elliptical, oblong, elongated, square, rectangular, polygonal, and the like.

In the component 200 of FIGS. 2A-2C, the cross section 203 may be substantially constant along the longitudinal direction 202. In other embodiments, the cross section 203 may be constant for a portion of the longitudinal length off the component 200. The cross section 203 may also vary along the longitudinal length of the component 200. In some embodiments, the cross section 203 may change and/or may include different shapes. For example, all or a portion of the cross section 203 may include a rectangular cross section, an oval cross section, a smashed circular cross section, a hexagonal cross section, an L-shape cross section, a U-shape cross section, a C-shape cross section, an S-shape cross section, and the like. It will be appreciated that the cross section 203 may have other suitable shapes, sizes, configurations, and arrangements depending, for example, upon the intended use of the component 200.

The component 200 may be constructed using a roll forming process, such as a continuous inline roll forming process. For example, the component 200 may be constructed from a strip of material that begins as a substantially flat or planar piece of material. The component 200 may also be constructed from a piece or portion of a stock material and the stock material may have an initially substantially flat or planar profile. The strip of material may have an initially generally rectangular cross section and may have a generally smooth or flat outer surface. The rectangular cross section of the strip of material may be solid (e.g., instead of rectangular shell). In the roll forming process, such as the continuous inline roll forming process, the strip of material may be embossed with the profile 201. Following the profile 201 being embossed in the strip of material, the shape of the strip of material may be modified until the shape includes the desired cross section, such as the cross section 203. It will be appreciated, after reviewing this disclosure, that the component 200 may be formed from materials with other shapes, sizes, configurations, and arrangements depending, for example, upon the intended use of the component.

A welding process may be used to form the component 200. For example, a roll forming process, such as the continuous inline roll forming process, may include a welding process. In an exemplary embodiment of the component 200, the welding process may be used to form a welding joint. The welding joint may be disposed substantially parallel to the longitudinal direction in which the component 200 is formed. As shown in FIGS. 2A-2C, the welding joint may be difficult to see because the profile 201 may be sized and configured such that when the strip of material is modified to the cross section 203, the ends of the strip of material may be separated by a uniform or substantially uniform distances. Accordingly, the welding joint may be formed that is consistent along the longitudinal direction 202. Advantageously, the profile 201 may help hide or conceal the welding joint, which may allow the component 200 to have a generally uniform appearance. In addition, the profile 201 may be sized, shaped, configured, and/or arranged to help create a component 200 with generally uniform properties and/or characteristics.

The roll forming process, such as the continuous inline roll forming process, may include a weld cleaning process and/or a cutting process. The weld cleaning process may include removal of slag or material left over from the welding process. The cutting process may cut the component 200 to a particular length.

The continuous inline roll forming process may provide substantial benefits over other manufacture processes. For instance, in previous manufacture processes, the profile (e.g., 201) would be embossed on an entire coil. The coil would then be cut down to strips of material. The strips of material would then be roll formed and welded. This previous process introduced significant wastes. For instance, because the entire coil is embossed, which may result in some portion of embossed material not being used. Additionally, the cutting of the embossed coiled material may interrupt the profile. Accordingly, at the locations in which the cuts are made, there may be inconsistencies and the inconsistencies may lead to a poor weld, inconsistent products, and the like. In additional, the embossing of the entire coil introduces an entire process that occurs outside the specific component manufacture process. This may introduce inefficiencies in the handling and/or storage of the material. For example, the coil may have to be transported to be embossed and then stored after being embossed. These wastes are overcome by the continuous inline roll forming process.

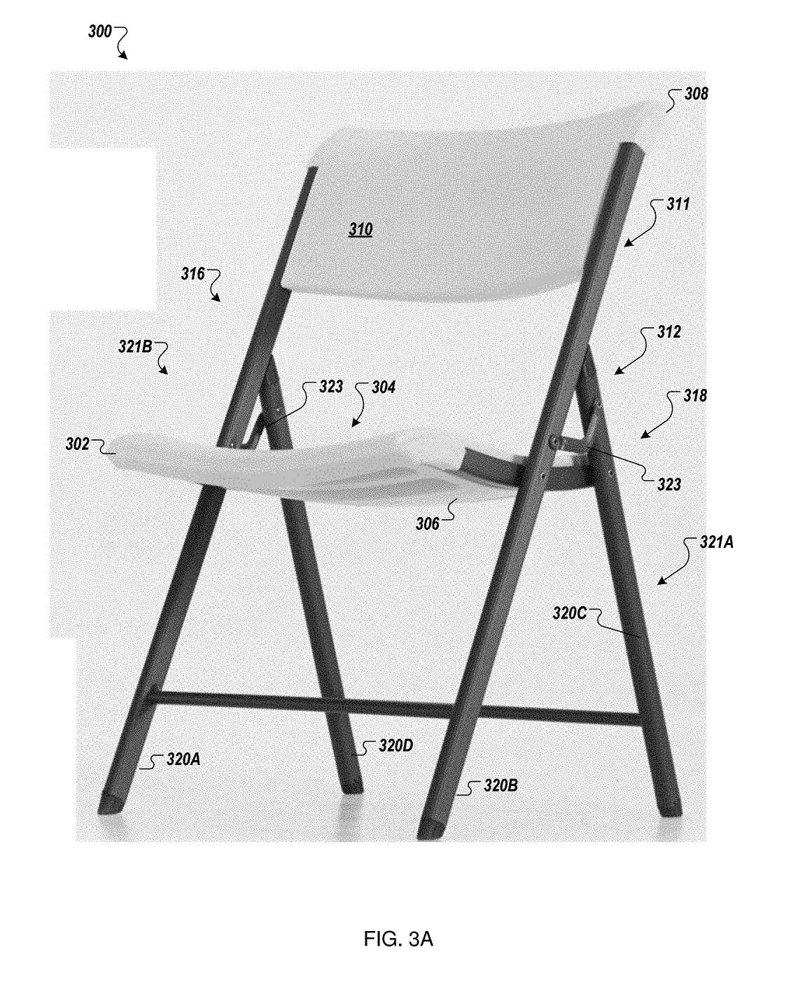

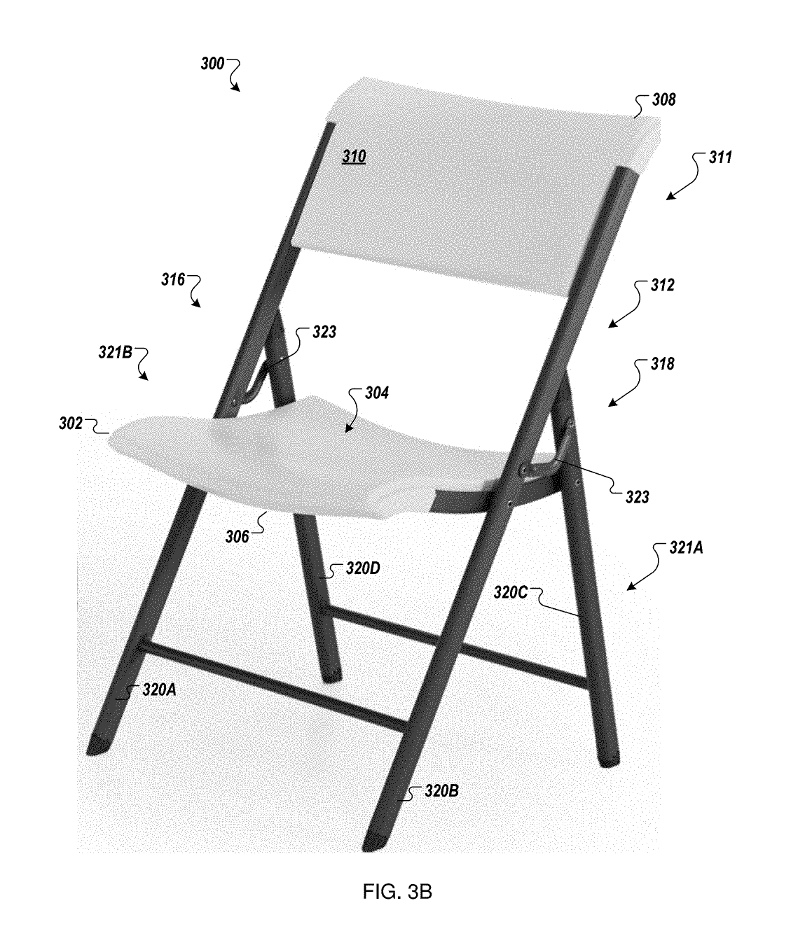

FIGS. 3A and 3B illustrate an exemplary chair 300 in which one or more components having an embossed profile may be implemented. FIG. 3A depicts a lower perspective view of the chair 300. FIG. 3B depicts an upper perspective view of the chair 300. The chair 300 may include a seat 302 with a top surface 304 or portion and a lower surface 306 or portion. The lower surface 306 may be generally opposite the top surface 304. After reviewing this disclosure, one skilled in the art will appreciate that the chair 300 may include any suitable number of components with an embossed profile. In addition, different components may have different embossed profiles and different portions of the components may have different embossed profiles.

As shown in the accompanying figures, the chair 300 may include a chair back or backrest 308. The backrest 308 may include a front surface 310 or portion and a rear surface 311 or portion. The rear surface 311 may be generally opposite the front surface 310. A frame 312 may connect the seat 302 to the backrest 308. The frame 312 may be used to support the seat 302 and the backrest 308 relative to a surface such as a floor on which the chair 300 is placed. The seat 302, backrest 308, and one or more features or components thereof may be separate components or integrally formed as part of a unitary, one-piece structure.

The frame 312 may include a left side portion 316 and a right side portion 318 that are connected to the seat 302 and backrest 308. The frame 312 may also include or be attached to one or more supports or legs, such as legs 320A-320D (generally, legs 320 or leg 320), which may be used to support the chair 300 above a surface such as a floor or the ground. An exemplary embodiment of the chair 300 may include a right front leg 320A, a left front leg 320B, a right rear leg 320D and a left rear leg 320C. The frame 312 may also include two leg assemblies 321A and 321B. For example, a first leg assembly 321A may include the right front leg 320A and the right rear leg 320D, and a second leg assembly 321B may include the left front leg 320B and the left rear leg 320C. After reviewing this disclosure, it will be appreciated that the chair 300 may include any suitable number and configuration of legs 320 depending, for example, upon the intended use and/or design of the chair 300.

One or more brackets 323 may be used to connect the legs 320, the frame 312, the seat 302, the backrest 308, or any combination thereof. For example, the bracket 323 may be attached to the seat 302 and one or more of the legs 320. For instance, the front legs 320A and 320B may be attached to the bracket 323 and the legs may be pivotally attached to the bracket 323. The bracket 323 may also connect the rear legs 320C and 320D to the seat 302. One of ordinary skill in the art, after reviewing this disclosure, will understand that the legs 320 may also be attached directly or indirectly to the seat 302, or other suitable portions of the chair 300, depending, for example, upon the intended use of the chair 300. Moreover, the frame 312, the seat 302, backrest 308, the legs 320, or any combination thereof may also be connected by a friction, interference or snap fit connection, or other suitable means.

The chair 300 may be a folding chair that is be movable between folded or collapsed positions and unfolded or use positions. The use position of the chair 300 is illustrated in FIGS. 3A and 3B. Accordingly, the legs 320 may be pivotally connected to the seat 302. For example, the chair 300 may include legs 320 that are pivotally connected at least proximate a midpoint of the legs 320. In particular, the right front leg 320A may be pivotally connected to the right rear leg 320D, and the left front leg 320B may be pivotally connected to the left rear leg 320C. It will be appreciated that the legs 320 may be connected in other suitable arrangements depending, for example, upon the size, shape, configuration, arrangement and/or intended use of the chair 300.

When the chair 300 is configured in the use position, a lower portion of the right front leg 320A and a lower portion of the right rear leg 320D may form two sides of a generally equilateral triangle and/or an upper portion of the right front leg 320A and an upper portion of the right rear leg 320D may form two sides of a generally equilateral triangle. Further, when the chair 300 is in the unfolded position, a lower portion of the left front leg 320B and a lower portion of the left rear leg 320C may form two sides of a generally equilateral triangle and/or an upper portion of the left front leg 320B and an upper portion of the left rear leg 320C may form two sides of a generally equilateral triangle.

The frame 312 may be configured to transition the chair 300 from a use configuration, which is depicted in FIGS. 3A and 3B, to a storage configuration. In the use configuration, the seat 302 may be positioned substantially parallel to a surface on which the chair 300 is placed and the backrest 308 is positioned at an angle 314 relative to the seat 302. In some embodiments, the angle 314 may be about ninety (90) degrees, between about ninety (90) degrees and about 110 degrees, between about ninety (90) degrees and about 120 degrees, between about ninety (90) degrees and about 130 degrees, between about ninety (90) degrees and about 140 degrees, or another angle, which may be determined by the comfort of a user or upon the intended use of the chair 300.

In the use configuration, a user may sit on the chair 300 such that the back or portion thereof of the user may contact a portion of the front surface 310 of the backrest 308 and the buttocks or a portion thereof of the user may contact the top surface 304 of the seat 302.

Additionally, when seated on the chair 300, the portions of the user in contact with the seat 302 and/or the backrest 308 may get hot and/or lack ventilation. One or more ridges or channels may be disposed in the front surface 310 of the backrest and/or the top surface 304 of the seat 302, which may be configured to increase ventilation and/or air circulation. The channels may provide additional airflow, which may increase ventilation.

The chair 300 may be sized and configured for use by a single person, but the chair may also be sized and configured to allow two or more persons to sit on the chair 300 at one time. It will be understood that the chair 300 may include a variety of suitable shapes, sizes and configurations, depending, for example, upon the intended use of the chair 300. For example, the chair 300 may be larger or smaller, and it may include other suitable designs depending, for example, upon its intended appearance, aesthetics, and the like.

At least a portion of the chair 300 may be constructed from molded or formed materials such as plastic. In particular, a portion of the chair 300 may be constructed from molded plastic, such as blow-molded or injection-molded plastic. For example, the seat 302, the backrest 308, and/or one or more portions or components thereof may be constructed from blow-molded plastic. One skilled in the art, after viewing this disclosure, will appreciate that any suitable portion or portions of the chair 300 can be constructed from plastic and, for example, the chair 300 in its entirety may be constructed from plastic. In addition, one skilled in the art, after reviewing this disclosure, will appreciate that the seat 302 and the backrest 308 may be integrally formed as part of a unitary, one-piece structure. Thus, for example, the seat 302 and the backrest 308 may be constructed from blow-molded plastic, and the seat 302 and backrest 308 may be integrally formed as part of a unitary, one-piece structure.

In greater detail, the seat 302 or a component thereof may be constructed from plastic that is molded into the desired shape and configuration. Advantageously, the molded plastic seat 302 may allow a strong, durable and/or lightweight chair 300 to be quickly and efficiently manufactured. It will be appreciated that other suitable materials and processes may be used to construct the seat 302 and other portions of the chair 300. For example, the seat 302 or one or more components thereof may be constructed from wood, metal, etc. In addition, the seat 302 or one or more components thereof may be formed by various suitable methods or processes such as blow-molding, injection molding, extrusion molding, vacuum forming, tumble molding, and the like. It will also be appreciated that the seat 302 and backrest 308 are not required to be manufactured by the same process. For example, the seat 302 may be constructed from blow-molded plastic and the backrest 308 may be formed from vacuum or injection molded plastic.

Significantly, chairs (e.g., chair 300) may include one or more components constructed from plastic and the chairs may be quickly and efficiently manufactured. The components constructed from plastic, for example, may facilitate the quick and efficient manufacturing of the claims. Chairs (e.g., chair 300) constructed from plastic may also be formed into many different desired shapes and sizes. Advantageously, chairs (e.g., chair 300) including one or more components constructed from plastic may be durable, lightweight, easily manufactured, and strong. It will be appreciated that any suitable portions of the chair may be constructed from plastic, and all or a portion of the chair may be constructed from other materials with appropriate properties and characteristics.

The legs 320 may be constructed, for example, from a strong and durable material such as metal and, in particular, steel. Construction of the legs 320 from steel may help create a strong and sturdy chair (e.g., chair 300) that is able to support a significant amount of weight. The legs 320 may also be constructed from other materials with appropriate properties and characteristics such as other types of metals, plastics, composites, etc.

As discussed above, one or more parts of the chair 300 may be constructed from components with an embossed profile. For example, the legs 320 of the chair 300 may include an embossed profile. Advantageously, the embossed profile may provide one or more benefits to the chair 300. For instance, the embossed profile may increase rigidity and/or strength of the legs 320. Additionally, the embossed profile may add durability to the legs 320. In addition, the embossed profile may help hide or prevent damage to the legs 320. Further, the embossed profile may provide aesthetic benefits to the chair 300 and/or the legs 320.

The frame 312 may include one or more components (e.g., bracket 323, left side portion 316, the right side portion 318) with an embossed profile. The components of the frame 131 may be formed by roll forming process, such as the continuous inline roll forming process described elsewhere in the present disclosure. The components of the frame 312 may be formed into the desired configuration by known operations such as stamping and bending, and the components may be coated or painted as desired.

The frame 312 is desirably constructed from a relatively strong and sturdy material such as metal and, in particular, steel. In particular, the frame 312 may be constructed from hollow metal tubes or conduits that are bent or formed into the desired shapes and configurations. The frame 312 may have a generally circular, square, rectangular, oval, or other suitable cross-sectional configuration. The metal frame 312 may allow a strong, sturdy, and lightweight chair 300 to be constructed. The frame 312 may also be constructed from other materials with appropriate characteristics and the frame 312 may have other suitable shapes, sizes, configurations, and/or arrangements. In particular, the size and shape of the frame 312 may depend, for example, upon the intended use of the chair 300. Although not shown in FIGS. 3A and 3B, the front surface 310 of the backrest 308 and/or the top surface 304 of the chair seat 302 may include a padded or cushioned surface.

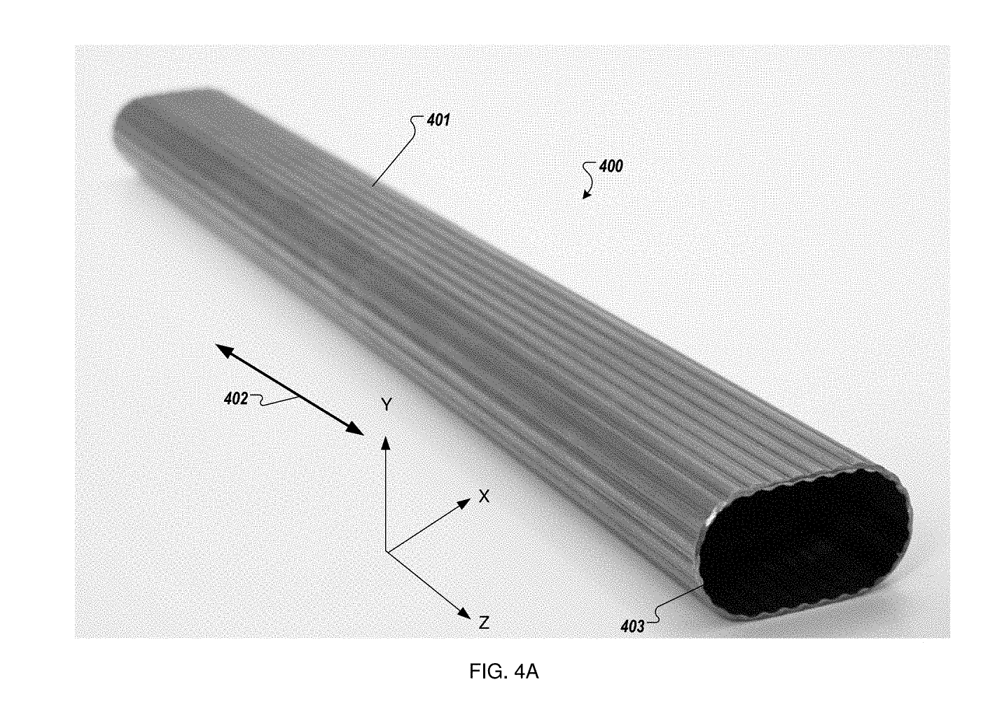

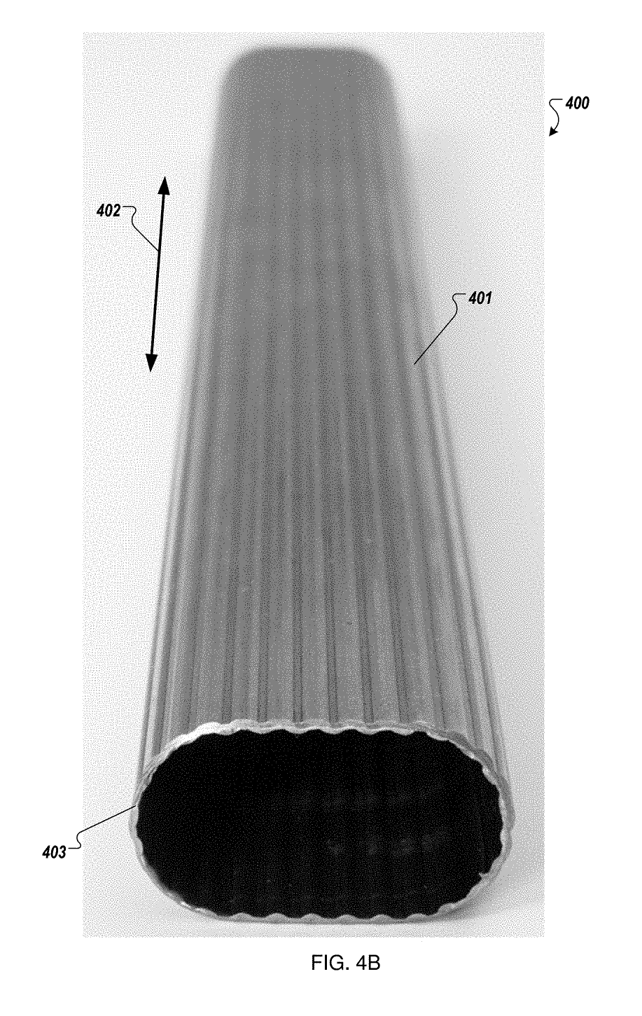

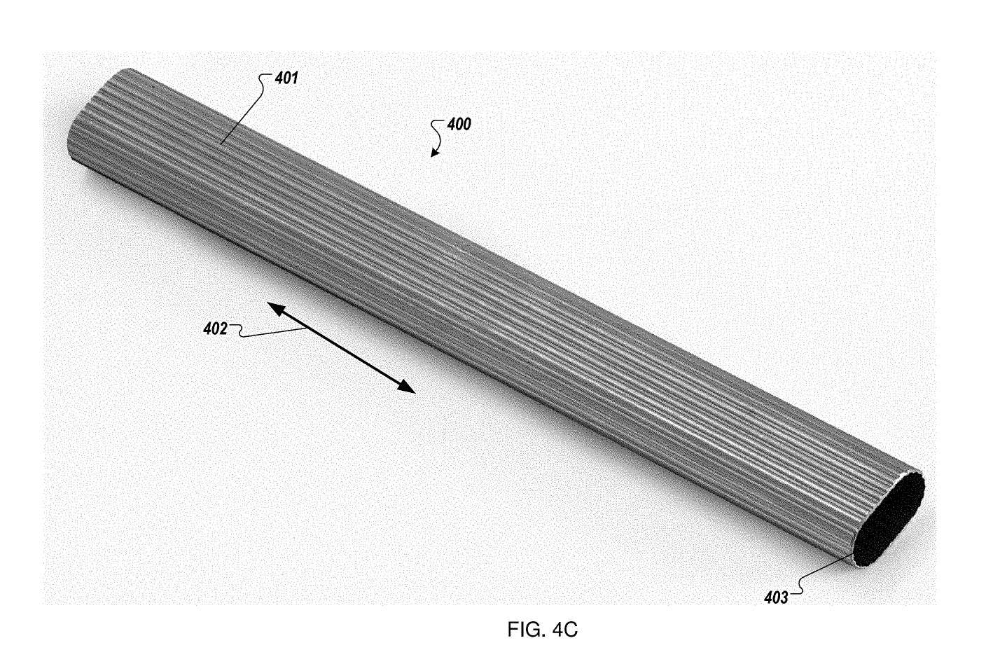

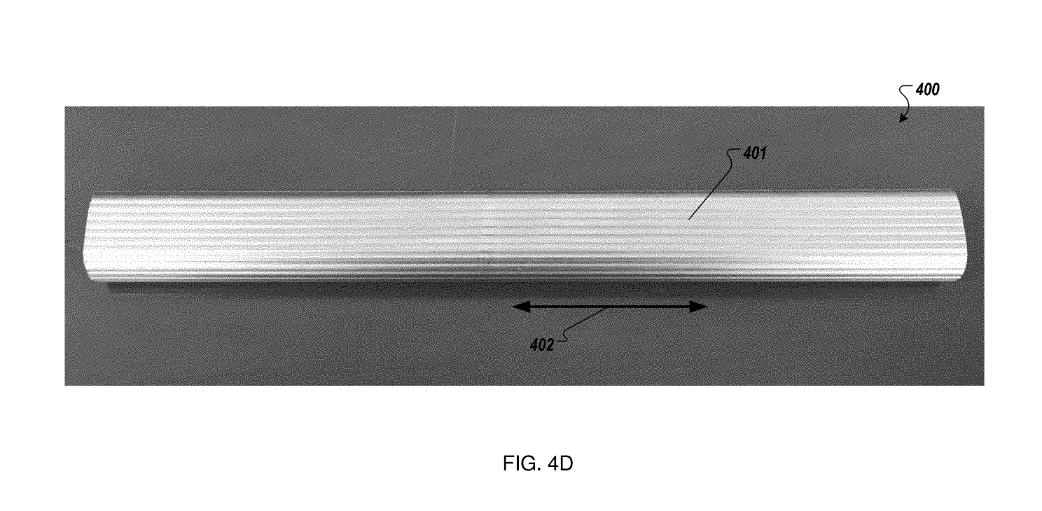

FIGS. 4A-4D illustrate a portion of an exemplary component 400 having an embossed profile. The component 400 may form at least a portion of one of the legs 320 and/or the frame 312 of the chair 300 shown in FIGS. 3A and 3B. FIG. 4A depicts a first perspective view of the component 400. FIG. 4B depicts a second perspective view of the component 400. FIG. 4C depicts a third perspective view of the component 400. FIG. 4D depicts a side view of the component 400.

The component 400 may be a tubular structure or a conduit type structure. The component 400 may extend in a longitudinal direction, which is represented by arrow 402 in FIGS. 4A-4D, and may have a longitudinal length. The component 400 may include a shell or ring of material. A profile 401 is embossed in the surfaces of the shell or ring of material. For example, the outer surface of the component 400 may form at least a portion of the shell or ring of material. The component 400 may also form the shell or ring of material. Thus, all or a portion of the component 400 may form the shell or ring of material

A profile 401 may be embossed in one or more surfaces of the shell or ring of material. In the exemplary embodiment shown in FIGS. 4A-4D, the profile 401 of the component 400 is a set of ribs that extend in the longitudinal direction 402. The ribs may be offset and/or spaced apart, and the ribs may be disposed in a pattern that extends around at least a portion of the shell or ring of material. In other embodiments, another profile may be embossed in the component 400. For example, the profile 401 may include a honeycomb pattern, dimples, pseudorandom patterns of lines and shapes, a pattern of rectangles, triangles, diamond plating, and the like. One skilled in the art, after reviewing this disclosure, will appreciate that the profile 401 may have other suitable shapes, sizes, configurations, and arrangements. Further, after reviewing this disclosure, one skilled in the art will appreciate that the profile 401 may be disposed in different directions, orientations, locations, and the like.

The shell or ring of material may define or form at least a portion of a cross section 403, which is shown in FIGS. 4A-4C. The cross section 403 may be an oval or smashed circle cross section. The cross section 403 may be defined in a plane that is substantially perpendicular to the longitudinal direction 402. For instance, as shown in FIG. 4A, an arbitrarily defined Cartesian coordinate system is depicted. The longitudinal direction may correspond to the z-direction. The cross section 403 may be defined in the XY-plane. It will be understood that other coordinate systems may be used and the component 200 may have other suitable cross sections such as generally round, circular, oval, elliptical, oblong, elongated, square, rectangular, polygonal, and the like.

The component 400, as shown in FIGS. 4A-4D, may have a cross section 403 that is substantially constant along the longitudinal direction. In other embodiments, the cross section 403 may be constant for a portion of the longitudinal length of the component 400. The cross section 403 may also vary along the longitudinal length of the component 400. In some embodiments, the cross section 403 may change and/or may include different shapes. For example, all or a portion of the cross section 403 may include a rectangular cross section, a circular cross section, a hexagonal cross section, an L-shape cross section, a C-shape cross section, an S-shape cross section, and the like. The component 400 may also have other suitable cross sections and the cross sections may vary. For example, the cross sections may vary along the longitudinal length of the component 400. It will be appreciated that the cross section 203 may have other suitable shapes, sizes, configurations, and arrangements depending, for example, upon the intended use of the component 200.

The component 400 may be constructed using roll forming process, such as a continuous inline roll forming process. For example, the component 400 may be constructed from a strip of material that begins as a substantially flat or planar piece of material. The component 400 may also be constructed from a piece or portion of a stock material and the stock material may have an initially substantially flat or planar profile. The strip of material may have an initially generally rectangular cross section and may have a generally smooth or flat outer surface. The rectangular cross section of the strip of material may be solid (e.g., instead of rectangular shell). In the roll forming process, such as the continuous inline roll forming process, the strip of material may be embossed with the profile 401. Following the profile 401 being embossed in the strip of material, the shape of the strip of material may be modified until the shape includes the desired cross section, such as the cross section 403. It will be appreciated, after reviewing this disclosure, that the component 400 may be formed from materials with other shapes, sizes, configurations, and arrangements depending, for example, upon the intended use of the component.

A welding process may be used to form the component 400. For example, a roll forming process, such as the continuous inline roll forming process, may include a welding process. In an exemplary embodiment of the component 400, the welding process may be used to form a welding joint. The welding joint may be disposed substantially parallel to the longitudinal direction in which the component 400 is formed. As shown in the accompanying figures, the welding joint may be difficult to see because, for example, the profile 401 may be sized and configured such that when the strip of material is modified to the cross section 403, the ends of the strip of material may be separated by a uniform or substantially uniform distances. Accordingly, the welding joint may be formed that is consistent along the longitudinal direction 402. Advantageously, the profile 401 may help hide or conceal the welding joint, which may allow the component 400 to have a generally uniform appearance. In addition, the profile 401 may be sized, shaped, configured, and/or arranged to help create a component 200 with generally uniform properties and/or characteristics.

The roll forming process, such as the continuous inline roll forming process, may include a weld cleaning process and/or a cutting process. The weld cleaning process may include removal of slag or material left over from the welding process. The cutting process may cut the component 200 to a particular length.

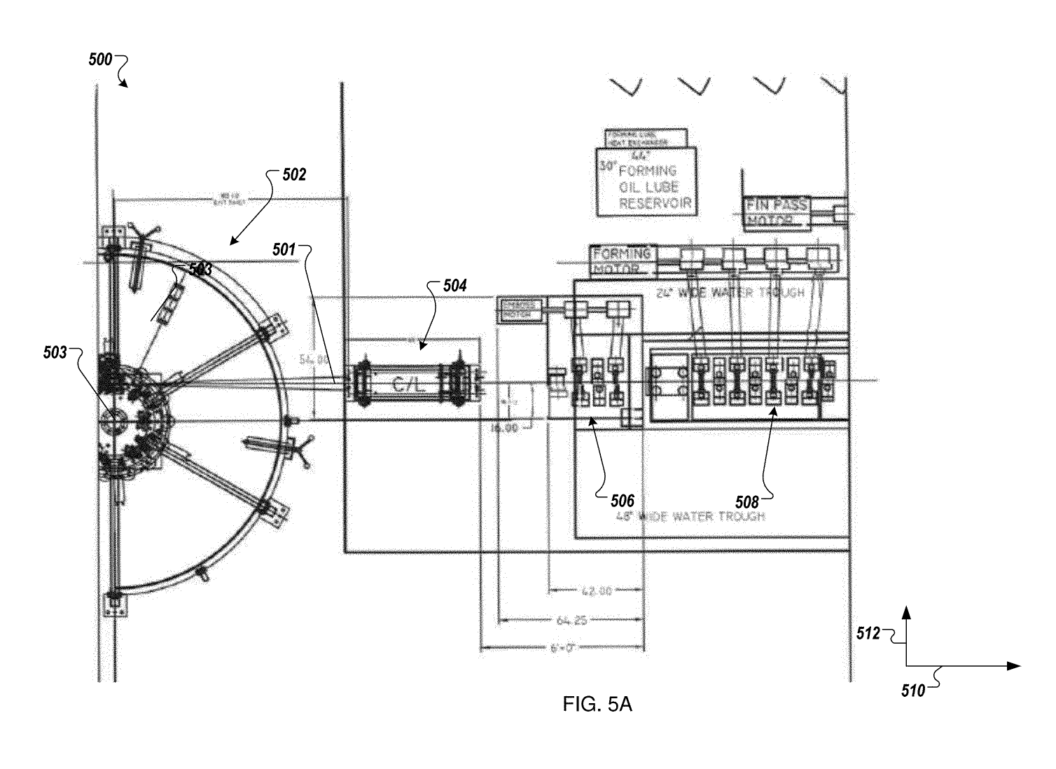

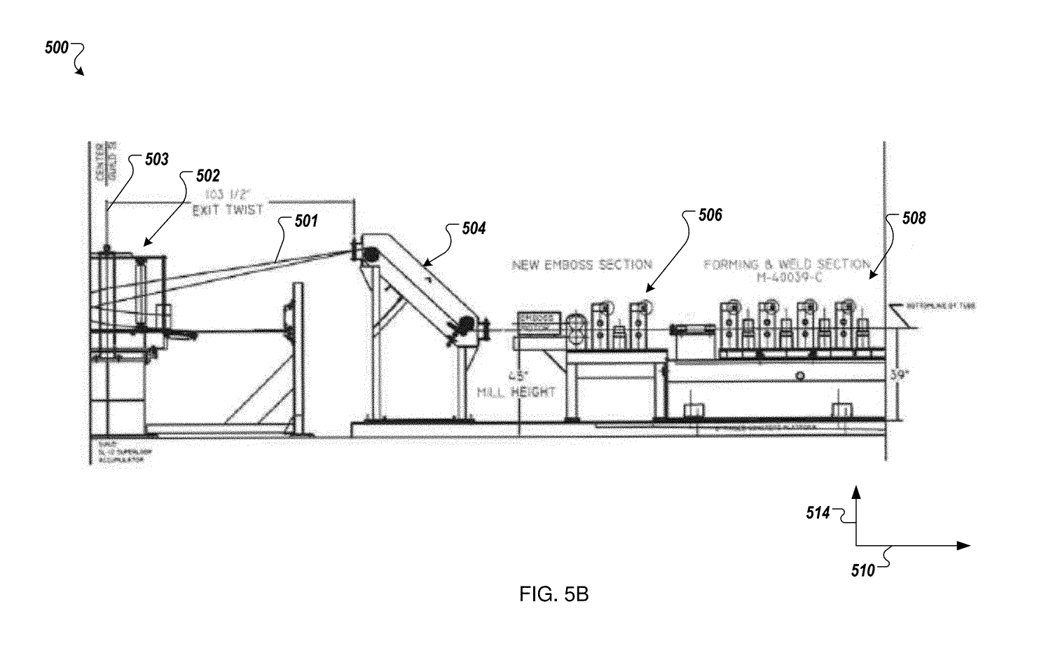

FIGS. 5A and 5B illustrate a schematic of an exemplary system 500 that may be implemented to manufacture one or more components having an embossed profile described in the present application. For example, the system 500 may construct the component 400 of FIGS. 4A-4D and/or the component 200 of FIGS. 2A-2C. In FIG. 5A, a top view of the system 500 is depicted. In FIG. 5B, a side view of the system 500 is depicted. After reviewing this disclosure, one skilled in the art will appreciate that the system 500 may make a variety of different components, structures, and the like.

With combined reference to FIGS. 5A and 5B, the depicted system 500 may include an accumulator 502, a centering mechanism 504, an emboss section 506, and/or a forming and weld section 508. In some embodiments, the system 500 may omit one or more of the accumulator 502, the centering mechanism 504, and the forming and weld section 508. For example, the system 500 may not include the depicted forming and weld section 508 in implementations in which the component is not welded (e.g., an angled, embossed component). Additionally, in some embodiments, the system 500 may include one more other machines. For example, the system 500 may include a cut-off die, which may cut the components to one or more particular lengths in a longitudinal direction, which is represented in FIGS. 5A and 5B by arrow 510. Additionally, the system may include a weld-cleaning die. The weld-cleaning die may clean slag and/or excess material from a welding joint formed by the forming and weld section 508.

The system 500 may be configured to perform a manufacturing process that results in construction or a portion of the construction of one or more components, such of one or more of the embossed components described in the present disclosure. For instance, the system 500 may, in some embodiments, perform the method 700 described elsewhere herein.

To construct an embossed component, according to an exemplary embodiment, a strip of material 501 may be fed from the accumulator 502 to the centering mechanism 504. The accumulator 502 may be configured similar to a large spool on which the strip of material 501 is wrapped. As the strip of material 501 is fed to the centering mechanism 504, the accumulator 502 may rotate about an axis 503.

The strip of material 501 may be formed from a piece or portion of material, such as a stock material. The stock material, for example, may be disposed in a roll or coil, such as a roll or coil of metal. In an exemplary embodiment, the strip of material 501 may be formed from a stock material such as steel coil. The stock material, for instance, may be stored on a coil that is between about three feet and about four feet is width. The strip of material 501 may include a portion that is cut from the stock material. For example, the strip of material 501 may include a strip width of about one inch, about two inches, about three inches, about four inches, or another strip width appropriate for the construction of the component. The strip of material 501 may be comprised of a metal or a metal alloy. For example, the strip of material 501 may be comprised of carbon steel, stainless steel, copper, brass, titanium, or aluminum.

The centering mechanism 504 may receive the strip of material 501 from the accumulator 502. The centering mechanism 504 may align the strip of material 501 with the emboss section 506. For example, the centering mechanism 504 may be configured to align the strip of material 501 in a vertical direction with the emboss section 506.

The emboss section 506 may be included inline in the system 500 between the centering mechanism 504 and the forming and weld section 508. In this exemplary embodiment, the emboss section 506 may receive the strip of material 501. The emboss section 506 may emboss a profile onto the strip of material 501. When the strip of material 501 enters the emboss section 506, the strip of material 501 may include a substantially rectangular cross section.

For example, the strip of material 501 may include a strip width that is defined between a first strip end or a first trip side and a second strip end or a second strip side. The strip width may be about one inch, about two inches, etc. The strip width may be defined in a lateral direction, which is represented in FIG. 5A by arrow 512. The lateral direction 512 may be substantially perpendicular to the longitudinal direction 510. The strip of material 501 may also include a strip thickness. The strip thickness may be a dimension in a vertical direction, which is represented by arrow 514 in FIG. 5B. Thus, the strip of material 501 when entering the emboss section 506 may include an initial cross section that includes the dimensions of the strip thickness by the strip width.

As the strip of material 501 proceeds through the emboss section 506, a profile may be embossed into one or both surfaces of the strip of material 501. The emboss section 506 may include one or more rollers, such as one or more complementary sets of rollers. For instance, in each of the sets of rollers a protrusion may extend from a surface of a first roller. The protrusion may align with a cavity defined in a corresponding portion of a surface of a second roller. In other embodiments, the emboss section 506 may include another embossing apparatus such as a press.

Following the profile being embossed into the strip of material 501, the embossed strip of material may proceed to the forming and weld section 508. In particular, the emboss section 506 may be inline with the forming and weld section 508 in the system 500. Accordingly, the processes performed by the forming and weld section 508 may be performed immediately subsequent to the embossing process performed by the emboss section 506.

The forming and weld section 508 may modify the shape of the strip of material 501. For example, the forming and weld section 508 may transform the initial cross section (e.g., the substantially rectangular cross section) to a second cross section. The second cross section may include a circular cross section (e.g., as depicted in FIGS. 2A-2C), an oval cross section (e.g., as depicted in FIGS. 4A-4D), a rectangular-box cross section, a triangular cross section, a higher order polygonal (e.g., hexagonal, octagonal) cross section, an irregular cross section, etc.

In some embodiments in which the system 500 includes the forming and weld section 508, the second cross section may be configured such that the first strip end or the first strip side is positioned substantially adjacent to the second strip end or the second strip side. The profile may be defined such that in the second cross section, the first strip end or the first strip side and the second strip end or the second strip side are separated by a uniform or substantially uniform distances along the strip length. In these and other embodiments, the forming and weld section 508 may weld a longitudinal welding joint between the first strip end or the first strip side and the second strip end or the second strip side along at least a portion of the strip of material 501.

In other embodiments, one or both of the first strip end or the first strip side and the second strip end or the second strip side may be positioned adjacent to another part of the strip of material 501. The forming and weld section 508 may weld a longitudinal welding joint between the first strip end or the first strip side and the other part of the strip of material 501 and/or between the second strip end or the second strip side and the other part of the strip of material 501.

In yet other embodiments, the second cross section may not be welded. In these embodiments, the second cross section may proceed through the forming and weld section 508 being formed but not being welded. Thus, the components may include one or more welded portions or the components may not include a welded portion.

As mentioned above, in some embodiments, the system 500 may include a section in which material is removed from the welding joint. The material may be removed, for example, via a milling process, a scraping process, a grinding process, some other material removal process, or some combination thereof. Additionally, the system 500 may include a tool used to cut the strip of material 501. For example, the system 500 may cut the strip of material 501 in the plane that is substantially parallel to the plane of the second cross section.

The system 500 may be configured to maintain a particular line rate at which the components are constructed. For instance, a system that is similar to the system 500 with the emboss section omitted may proceed at a first line rate. The system 500 may incorporate the emboss section 506 without an increase in the first line rate. Accordingly, the system 500 may construct the components at a second line rate that is substantially similar to the first line rate. The system 500, however, could have a line rate with the emboss section 506 that is different than a line rate without the emboss section.

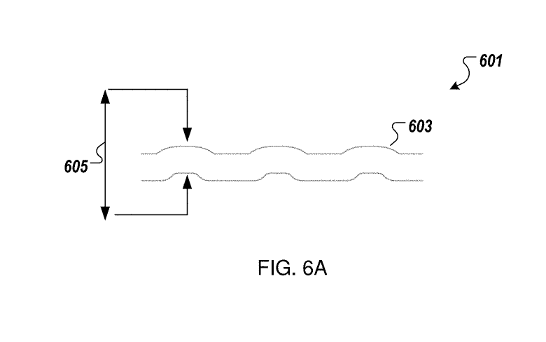

FIGS. 6A and 6B illustrate an exemplary of a strip of material 601 that includes an exemplary profile 603 embossed thereon. The profile 603 may be embossed on the strip of material 601 by an emboss section, such as the emboss section 506 shown in FIGS. 5A and 5B. The strip of material 601 may be formed into the component 200 of FIGS. 2A-2C, the component 400 of FIGS. 4A-4D, or other suitable component. For example, the forming and weld section 508 of FIGS. 5A and 5B may receive the strip of material 601 and modify the strip of material 601 into the component 200 or 400.

FIG. 6A depicts an enlarged side or a detailed end view of the strip of material 601. As shown in FIG. 6A, the strip of material 601 may include a thickness 605. The thickness 605 may be modified by the embossed profile 603. In general, the profile 603 may include a series of impressions made in the strip of material 601. The impressions may be aligned, offset, spaced apart, etc. depending, for example, upon the desired profile.

FIG. 6B depicts a perspective view of the strip of material 601. The profile 603 may include a pattern of offset ribs formed in a surface of the strip of material 601. The pattern of offset ribs may be formed in one or both sides of the strip of material 601. For example, a first pattern of ribs may be formed on a first side of the strip of material 601 and a second pattern of ribs may be formed on a second side of the strip of material. Thus, the ribs may be disposed on an opposite or opposing surfaces of the strip of material 601. The pattern of offset ribs may extend in a longitudinal direction, which is represented in FIG. 6B by arrow 607. To form the component 200 of FIGS. 2A-2C or the component 400 of FIGS. 4A-4D, the strip of material 601 may be modified such that a first strip end or a first strip side 609 and a second strip end or a second strip side 611 are separated by a uniform or substantially uniform distances along a strip length defined in the longitudinal direction 607. The first strip end or first strip side 609 and the second strip end or the second strip side 611 may be welded, if desired.

In some embodiments, the first strip end or the first strip side 609 and the second strip end or the second strip side 611 may not be welded to one another. In these and other embodiments, the first strip end or the first strip side 609 and/or the second strip end or the second strip side 611 may not be welded to another portion of the strip of material 601 or may be welded to a portion of the strip of material 601 between the first strip end or the first strip side 609 and the second strip end or the second strip side 611.

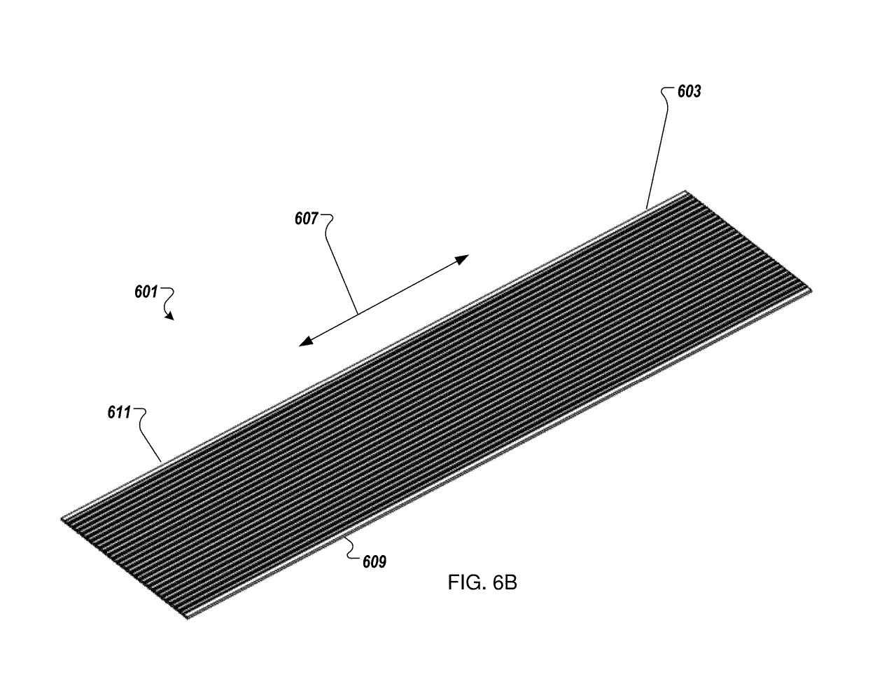

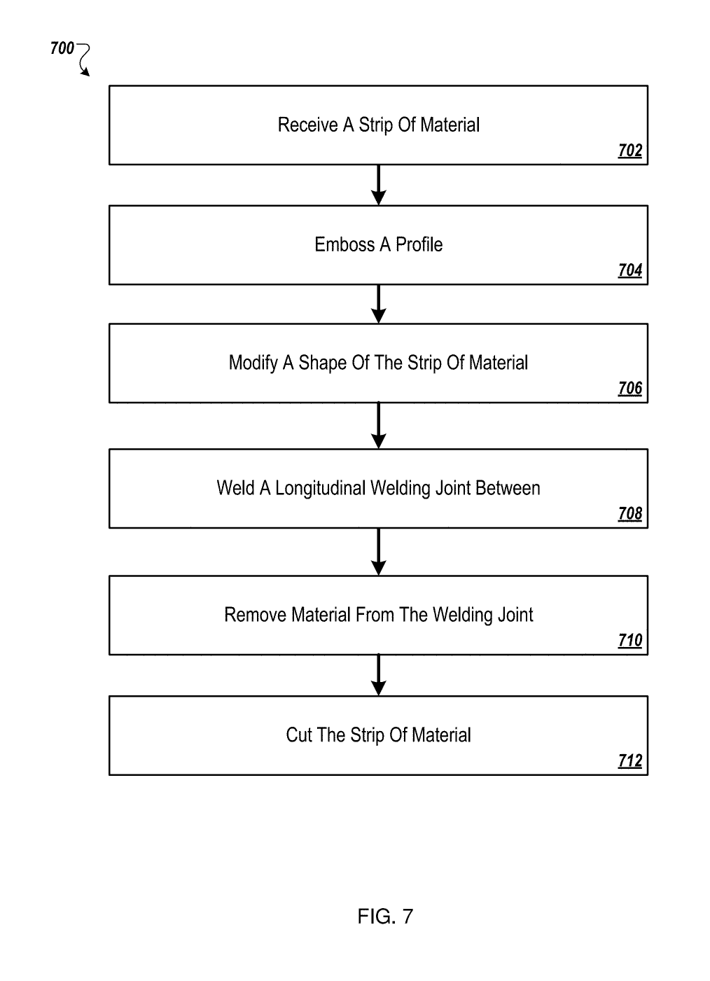

FIG. 7 is a flow chart of an exemplary method 700 of manufacturing a component, such as a component of an article of furniture. The method 700 may be performed by the system 500 of FIGS. 5A and 5B in some embodiments. The component of the article of furniture may include a leg of a table, a leg of a chair, a frame of a table, a frame of a chair, a leg of a bench, a leg of a picnic table, a frame of a bench, a frame of a picnic table, or a support structure of a composter, for instance. Although illustrated as discrete blocks, various blocks may be divided into additional blocks, combined into fewer blocks, or eliminated, depending on the desired implementation.

The method 700 may begin at block 702 in which a strip of material may be received. The strip of material may be constructed from a metal, such as a carbon steel or a stainless steel. In some embodiments, the strip of material may be constructed from a portion of a coil of stock material, such as a steel coil. The strip of material may include a strip width defined between a first strip end or a first strip side and a second strip end or a second strip side and a strip length, which may be larger than the strip width. The strip of material may include an initial cross section that may be defined in a plane that is substantially perpendicular to the strip length. The initial cross section may be rectangular and include the strip width and a strip thickness as dimensions.

At block 704, a profile may be embossed into one or more surfaces of the received strip of material. Embossing the profile may include a first inline process in a series of inline processes. The embossing of the profile may be performed by a roll forming process. In some embodiments, the profile may include a pattern of offset ribs formed in the surface of the received strip of material and an opposite surface of the received strip of material.

At block 706, a shape of the strip of material may be modified. For example, the shape of the strip may be modified such that the initial cross section is transformed to the second cross section. The modifying the shape may be performed by a roll forming process including at least two rollers. The modification of the shape of the strip of material may be a second inline process that is subsequent or immediately subsequent to the first inline process. In some embodiments, the second cross section may include the first strip end or the first strip side positioned substantially adjacent to the second strip end or the second strip side. Additionally, in these and other embodiments, the profile may be defined such that in a second cross section, the first strip end or the second strip side and the second strip end or the second strip side are separated by a uniform or substantially uniform distances along the strip length. Some examples of the second cross section include a substantially circular cross section, a substantially rectangular cross section, or a substantially oval cross section. It will be appreciated, after reviewing this disclosure, that the second cross section may have any suitable size, shape, configuration, and/or arrangement depending, for example, upon the intended use or design.

At block 708, a longitudinal welding joint may be welded. For example, the longitudinal welding joint may be formed between the first strip end or the first strip side to the second strip end or the second strip side along at least a portion of the strip length. The welding may be a third inline process that is subsequent or immediately subsequent to the second inline process.

At block 710 material may be removed from the welding joint. Removal of the material from the welding joint may be a fourth inline process that is subsequent or immediately subsequent to the third inline process.

At block 712, the strip of material may be cut. The strip of material may be cut in a plane that is substantially parallel to the second cross section. The cutting of the strip of material may be a fifth inline process that is subsequent or immediately subsequent to the fourth inline process. In some embodiments, the first inline process is performed at a same line rate of the second inline process and the third inline process.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments.

FIGS. 8-18 illustrate an exemplary embodiment of a chair that may include one or more components with an embossed profile. For example, one or more portions of the frame and/or legs may have an embossed profile. As shown in the accompanying figures, for example, the legs may include an embossed profile and the profile may include a series of outwardly extending portions and/or inwardly extending portions. The outwardly and/or inwardly extending portions may extend generally along a length of the legs and the outwardly and/or inwardly portions may extend at least substantially the length of the legs. The outwardly and/or inwardly extending portions may be disposed about at least substantially the entire outer surface of the legs. In addition, the same pattern of outwardly and/or inwardly extending portions may be disposed in each of the legs. After reviewing this disclosure, one skilled in the art will appreciate that the various components of the chair may include other embossed profiles. The embossed profiles may have other patterns and the embossed profiles may have different shapes, sizes, configurations, and/or arrangements depending, for example, upon the intended use or design of the chair.

One of ordinary skill in the art will appreciate after reviewing this disclosure that the chair and the table may have other suitable shapes, sizes, configurations, and arrangements depending, for example, upon the intended use of the chair and the table. One of ordinary skill in the art will also appreciate that different components of the chair and the table may have various shapes, sizes, configurations, and arrangements depending, for example, upon the intended use of the chair and the table. Further, one of ordinary skill in the art will appreciate the chair and the table may include any suitable number or combination of features or aspects.

Although this invention has been described in terms of certain preferred embodiments, other embodiments apparent to those of ordinary skill in the art are also within the scope of this invention. Accordingly, the scope of the invention is intended to be defined only by the claims which follow.

What is claimed is:

1. A method of manufacturing a component of an article of furniture, the method comprising:
receiving a strip of material, wherein:
the strip of material includes a portion of a coil of stock material;
the strip of material includes a strip width;
the strip of material includes a strip length;
the strip of material includes an initial cross section; and
the initial cross section of the received strip of material is generally rectangular;
in a first inline process, embossing a profile into a surface of the received strip of material;
in a second inline process that is subsequent to the first inline process, modifying a shape of the strip of material such that the initial cross section is transformed to a second cross section that is different than the initial cross section; and
in a third inline process that is subsequent to the second inline process, welding a longitudinal welding joint between the first strip end to the second strip end along at least a portion of the strip length.

2. The method of claim 1, further comprising in a fourth inline process that is subsequent to the third inline process, the fourth inline process comprising removing material from the welding joint.

3. The method of claim 2, further comprising in a fifth inline process that is subsequent to the fourth inline process, the fifth inline process comprising cutting the strip of material in a plane generally aligned the second cross section.

4. The method of claim 1, wherein the first strip end and the second strip end are separated by a uniform or substantially uniform distances along the strip length in the second cross section.

5. The method of claim 1, wherein the profile includes a pattern of offset ribs formed in the received strip of material.

6. The method of claim 1, wherein the second cross section is substantially circular, substantially rectangular, or substantially oval.

7. The method of claim 1, wherein the strip of material is received from an accumulator.

8. The method of claim 1, wherein the modifying the shape is performed by a roll forming process including at least two rollers.

9. The method of claim 1, wherein the embossing the profile is performed by a roll forming process.

10. The method of claim 1, wherein the component of the article of furniture includes a leg of a table, a leg of a chair, a support frame of a table, a support frame of a chair, a leg of a bench, a leg of a picnic table, a support frame of a bench, a support frame of a picnic table, or a support structure of a composter.

11. The method of claim 1, wherein the strip of material is constructed from a carbon steel or a stainless steel.

12. The method of claim 1, wherein the first inline process is performed at a same line rate that is at least substantially the same as the line rate of second inline process and the line rate of the third inline process.

13. An article of furniture comprising:
a component comprising:
a strip of material having a first strip end, a second strip end, a strip length, a strip width, and a strip thickness;
a longitudinal welding joint between the first strip end to the second strip end along at least a portion of the strip length; and
a profile embossed into a surface of the strip of material,
wherein the component is manufactured in a continuous inline roll forming process.

14. The article of furniture of claim 13, wherein in the continuous inline roll forming process, the profile is embossed in a first inline process.

15. The article of furniture of claim 14, wherein in the continuous inline roll forming process, a shape of the strip of material is modified from an initial generally rectangular cross section to a second cross section in a second inline process that is subsequent to the first inline process, the second cross section being different than the initial generally rectangular cross section.

16. The article of furniture of claim 15, wherein in the continuous inline roll forming process, a longitudinal welding joint is formed in a third inline process that is subsequent to the second inline process.

17. The article of furniture of claim 15, wherein the component includes a table leg, a chair leg, a bench leg, or a picnic table leg.

18. The article of furniture of claim 13, wherein the strip of material includes a portion of a coil of stock material.
